(19) United States
(12) Patent Application Publication
(10) Pub. No.: US 2026/0058178 A1
(43) Pub. Date: Feb. 26, 2026

(54) BUFFER LAYER AND METHOD FOR MITIGATION OF PHOSPHATE POISONING IN HIGH-TEMPERATURE PROTON EXCHANGE MEMBRANE FUEL CELLS (HT-PEMFC)

(71) Applicant: Toyota Motor Engineering & Manufacturing North America, Inc., Plano, TX (US)

(72) Inventor: Liang Wang, Saline, MI (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/810,895

(22) Filed: Aug. 21, 2024

(51) Int. Cl. H01M 8/1004; H01M 4/92; H01M 50/414; H01M 50/449; H01M 50/46

(52) U.S. Cl. CPC H01M 8/1004; H01M 4/921; H01M 50/414; H01M 50/449; H01M 50/46

(57) ABSTRACT

The present disclosure relates to high-temperature proton exchange membrane fuel cells (HT-PEMFC) having phosphoric acid as a proton conductor, and methods for mitigating phosphate poisoning of the catalyst in the fuel cell. The fuel cells and the method include a buffer layer between metal catalyst nanoparticles and at least one polymeric ionomer layer. The buffer layer includes a protic ionic liquid having a high melting point greater than 160° C., and the ratio of the protic ionic liquid to carbon (IL/C) is from about 0.1 to about 0.2.

### TECHNICAL FIELD

The present disclosure generally relates to high-temperature proton exchange membrane fuel cells (HT-PEMFC) having phosphoric acid as a proton conductor, and a protic ionic liquid buffer layer for mitigating phosphate poisoning of the catalyst in the fuel cell.

### BACKGROUND

The background description provided herein is for the purpose of generally presenting the context of the disclosure. Work of the presently named inventors, to the extent it may be described in this background section, as well as aspects of the description that may not otherwise qualify as prior art at the time of filing, are neither expressly not implicitly admitted as prior art against the present technology.

Fuel cell vehicles (FCVs) are considered to be more efficient than conventional internal combustion engine vehicles and they have a zero emission powertrain platform. All current commercially available fuel cell vehicles use proton exchange membrane fuel cells (PEMFCs), which include stacks of membrane electrode assemblies (MEAs). While PEMFC technology has been commercialized for decades, it still faces major challenges of high material costs and substantial performance gaps. The presence of a polymer ionomer in PEMFC MEAs also adversely affects the performance of catalyst due to physical barriers to reactant gas transport and loss of active sites through specific adsorption of polymer-bound sulfonate groups on the catalyst surface.

Heavy duty vehicles (HDVs) generate more waste and require a higher temperature (>120° C.) compared to light-duty vehicles (LDVs) to meet the automotive heat rejection constraint. One of the major challenges for applying proton exchange membrane fuel cells (PEMFCs) to heavy-duty applications (e.g., class 8 trucks) is the heat dissipation limitation. Low-temperature proton exchange membrane fuel cells (LT-PEMFCs) that typically operate between 60° C.-80° C. make them unfavorable to be used for heavy-duty applications because of the low-temperature difference between the fuel cell and the environment. LT-PEMFCs generally employ a proton exchange membrane that conducts proton when the membrane is properly hydrated by water. The typical commercialized membrane is perfluorinated sulfonic-acid (PFSA). The PFSA relies on water to conduct proton so that the LT-PEMFCs can be functional. Anhydride PFSA does not conduct proton. Moreover, due to the thermal stability limitation of PFSA polymer, the LT-PEMFCs are usually not stable when operating above 120° C. (glass transition temperature of PFSA).

In order to improve the heat rejection of fuel cell stacks, fuel cells that operate at higher temperatures are preferred for heavy-duty applications where high-power output leads to high waste heat generation. For HT-PEMFCs that can operate above 110° C., preferably above 140° C. and ideally between 160° C.-200° C., water cannot be used for humidifying the proton conductor (electrolyte, typically PFSA) because of the low boiling point (100° C.). A thermally stable proton conductor has to be used for such high temperatures (120° C.-200° C.). Phosphoric acid (PA) is thermally stable at this temperature range and a good proton conductor below 200° C. Above 200° C., phosphoric acid suffers from anhydride formation and evaporation.

Several efforts have been made to use phosphoric acid as the proton conductor both in the membrane and electrode of PEMFCs. In fuel cells employing phosphoric acid as the proton conductor in the membrane electrode assembly (MEAs), a major issue is the poisoning of the oxygen reduction reaction catalyst (typically a platinum (Pt) containing catalyst). The phosphate anion from phosphoric acid adsorbs on Pt catalyst surface and reduces electrochemical surface area (ECSA) and the ability of Pt catalyst to bond with oxygen reduction reaction (ORR) intermediates for electrochemically catalyzing oxygen to form water. Some efforts to address the problem of phosphate poisoning in high-temperature proton exchange membrane fuel cells (HT-PEMFCs) have been to design phosphate-tolerant catalyst materials, phosphate-tolerant supports, and/or polymer exchange membranes that retain phosphoric acid. There is still a desire to develop strategies and materials to mitigate phosphate poisoning in HT-PEMFCs to maintain efficiency and longevity.

### SUMMARY

This section provides a general summary of the disclosure and is not a comprehensive disclosure of its full scope or all of its features.

In various aspects, the present teachings provide a membrane electrode assembly (MEA) for a high-temperature proton exchange membrane fuel cell comprising phosphoric acid as a proton conductor. The MEA comprises a proton exchange membrane; at least one catalyst layer which comprises metal catalyst nanoparticles on a carbon support that contacts the proton exchange membrane; at least one polymeric ionomer layer; and a buffer layer between the metal catalyst nanoparticles and the at least one polymeric ionomer layer. The buffer layer comprises a protic ionic liquid having a high melting point greater than 160° C., and the ratio of the protic ionic liquid to carbon (IL/C) is from about 0.1 to about 0.2. In some examples, the ratio of the liquid to carbon (IL/C) is from about 0.1 to about 0.2 or about 0.15. In some examples, the metal catalyst nanoparticles of the catalyst layer comprise platinum or platinum alloy. In some examples, the protic ionic liquid may have a high molecular weight greater than 1000 g/mol. In some examples the protic ionic liquid of the buffer layer comprises 9′9′-(butane-1,4-diyl)bis(3,4,6,7,8,9-hexahydro-2H-pyrimido[1,2-alpyrimidin-1-ium) 1,1,2,2,3,3,4,4,4-nonafluorobutane-1-sulfonate having the following chemical structure:

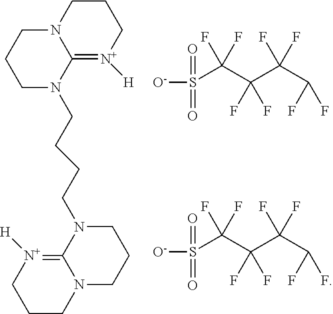 [SMILES: C(CCN1CCCN2CCC[NH+]=C12)CN1CCCN2CCC[NH+]=C12 ; O=S(=O)([O-])C(F)(F)C(F)(F)C(F)(F)C(F)F ; O=S(=O)([O-])C(F)(F)C(F)(F)C(F)(F)C(F)F]

In the present disclosure, the proton exchange membrane and/or the at least one polymeric ionomer layer may comprise phosphoric acid doped polybenzimidazole (PA/PBI), quaternary ammonium phosphate ion pair polymers, polyvinylphosphonic acid (PVPA), sulfonated polyether ether ketone (SPEEK), poly(arylene ether sulfone) (PAES), sulfonated polyimides, perfluorosulfonic acid (PFSA) polyvinylidene fluoride (PVDF) copolymers, or combinations thereof.

In another aspect, the present disclosure relates to a high-temperature proton exchange membrane fuel cell (HT-PEMFC) comprising phosphoric acid as a proton conductor. The HT-PEMFC comprises a membrane electrode assembly (MEA) for a high-temperature proton exchange membrane fuel cell which comprises a proton exchange membrane; at least one catalyst layer comprising metal catalyst nanoparticles on a carbon support that contacts the proton exchange membrane; at least one polymeric ionomer layer; and a buffer layer between the metal catalyst nanoparticles and the at least one polymeric ionomer layer. The buffer layer comprises a protic ionic liquid having a high melting point greater than 160° C., and the ratio of the protic ionic liquid to carbon (IL/C) is from about 0.1 to about 0.2. In some examples, the ratio of the liquid to carbon (IL/C) is from about 0.1 to about 0.2 or about 0.15. In some examples, the metal catalyst nanoparticles of the catalyst layer comprise platinum or platinum alloy. In some examples, the protic ionic liquid may have a high molecular weight greater than 1000 g/mol. In some examples, the protic ionic liquid comprises 9′9′-(butane-1,4-diyl)bis(3,4,6,7,8,9-hexahydro-2H-pyrimido[1,2-a]pyrimidin-1-ium) 1,1,2,2,3,3,4,4,4-nonafluorobutane-1-sulfonate. The proton exchange membrane and/or the at least one polymeric ionomer layer may comprise phosphoric acid doped polybenzimidazole (PA/PBI), quaternary ammonium phosphate ion pair polymers, polyvinylphosphonic acid (PVPA), sulfonated polyether ether ketone (SPEEK), poly(arylene ether sulfone) (PAES), sulfonated polyimides, perfluorosulfonic acid (PFSA) polyvinylidene fluoride (PVDF) copolymers, or combinations thereof.

In yet another aspect, the present disclosure relates to a method of mitigating phosphoric acid poisoning in a high-temperature proton exchange membrane fuel cell (HT-PEMFC) comprising phosphoric acid as a proton conductor. The method comprises: providing at least one catalyst layer which comprises metal catalyst nanoparticles on a carbon support and at least one polymeric ionomer layer; and applying a buffer layer between the at least one catalyst layer and the at least one polymeric ionomer layer. The buffer layer comprises a protic ionic liquid having a high melting point greater than 160° C., and the ratio of the protic ionic liquid to carbon (IL/C) is about 0.5 to about 2.0. In some examples the ratio of the protic ionic liquid to carbon (IL/C) is from about 0.1 to about 0.2 or about 0.15. In some examples, the metal catalyst nanoparticles comprise platinum or platinum alloy. In some examples, the protic ionic liquid further has a high molecular weight of greater than 1000 mol/g. In some examples, the protic ionic liquid comprises 9′9′-(butane-1,4-diyl)bis(3,4,6,7,8,9-hexahydro-2H-pyrimido[1,2-a]pyrimidin-1-ium) 1,1,2,2,3,3,4,4,4-nonafluorobutane-1-sulfonate. The proton exchange membrane and/or the at least one polymeric ionomer layer may comprise phosphoric acid doped polybenzimidazole (PA/PBI), quaternary ammonium phosphate ion pair polymers, polyvinylphosphonic acid (PVPA), sulfonated polyether ether ketone (SPEEK), poly(arylene ether sulfone) (PAES), sulfonated polyimides, perfluorosulfonic acid (PFSA) polyvinylidene fluoride (PVDF) copolymers, or combinations thereof.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings wherein:

FIG. 1A is an illustration of the typical structure of a proton exchange membrane fuel cell (PEMFC) 100.

FIG. 1B is an illustration of an enlarged view of an interface section labeled 1B in 1A.

FIG. 1C is an illustration of an enlarged view of a traditional carbon support loaded with metal catalyst particles in the interface in FIG. 1B.

FIG. 2 is an illustration of a typical membrane electrode assembly (MEA) 110.

FIG. 3 is a graphic illustration of the results from a comparison of different concentrations of phosphoric acid (H₃PO₄) to perchloric acid (HClO₄) (reference) without phosphate ions based on a plot of the current density (j) in milliamperes per square centimeter (mA cm²) versus potential (E) in volts (V) versus the reversible hydrogen electrode (RHE).

FIG. 4 is a schematic illustration of a cathode electrode 400 of the present disclosure including a buffer layer 420, between a catalyst layer 410 comprising a metal catalyst 411 (e.g., catalyst nanoparticles) on a carbon support 412, and polymeric ionomer layer 430.

FIG. 5A is an illustration of a membrane electrode assembly (MEA) 500 of the present disclosure.

FIG. 5B is an illustration of an enlarged view of a carbon support loaded with metal catalyst particles including a buffer layer of the present disclosure.

FIG. 6A is a schematic cross-sectional view of a high-temperature proton exchange membrane fuel cell (HT-PEMFC) 600 of the present disclosure including a cathode electrode 640 comprising a buffer layer 644 between the cathode catalyst layer 643 and a polymeric ionomer layer 645.

FIG. 6B is a schematic cross-sectional view of a portion of an exemplary HT-PEMFC of the present disclosure.

FIG. 7 is a bar graph showing the results of a comparison of the oxidation reduction reaction (ORR) mass activity of Pt/C catalyst with the protic ionic buffer layer of the present disclosure at different ionic liquid to carbon (IL/C) ratios.

FIG. 8 is a graphic illustration of HT-PEMFC performance at a low current density with Pt/C catalyst and a buffer layer of the present disclosure at various ratios of the protic ionic liquid to carbon (IL/C) in the cathode electrode at 160° C., 0.5NLPM H₂/Air, 148 kPa (abs.) based on a comparison of polarization curves depicting the relationship between the voltage (V) and the current density (A/cm²).

It should be noted that the figures set forth herein are intended to exemplify the general characteristics of the methods, algorithms, and devices among those of the present technology, for the purpose of the description of certain aspects. These figures may not precisely reflect the characteristics of any given aspect and are not necessarily intended to define or limit specific embodiments within the scope of this technology. Further, certain aspects may incorporate features from a combination of figures.

### DETAILED DESCRIPTION

The present disclosure provides a cathode electrode designed for high-temperature proton exchange membrane fuel cells (HT-PEMFCs) that employ phosphoric acid as the proton conductor and a method for mitigating phosphate poisoning of the catalyst in the membrane electrode assembly (MEA). For purposes of this disclosure, “mitigating” refers to reducing, alleviating, and/or preventing the leaking or leaching of phosphate ions and/or the negative effects of phosphate ions on the electrochemical performance of a fuel cell.

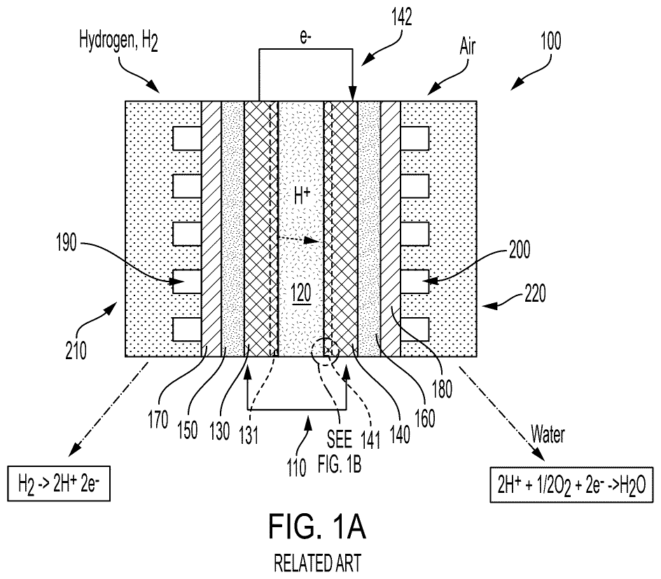

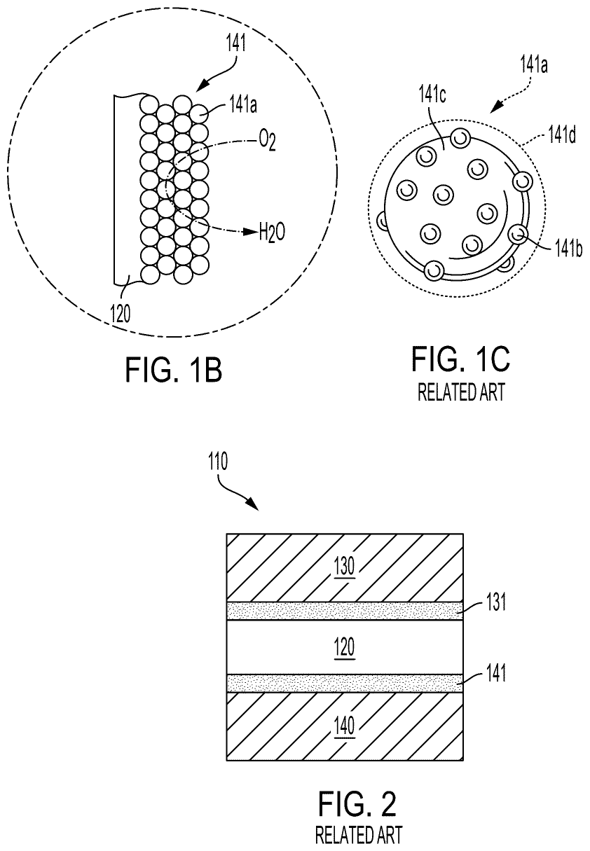

FIGS. 1A-1C illustrate the components and operation of a typical PEMFC 100, including both low-temperature proton exchange membrane fuel cells (LT-PEMFCs) and high-temperature proton exchange membrane fuel cells (HT-PEMFCs). For purposes of this disclosure, the terms “proton exchange membrane fuel cell” and “polymer electrolyte membrane fuel cell” may be used interchangeably to refer to PEMFCs generally. The PEMFC 100 includes a membrane-electrode assembly (MEA) 110, which comprises a proton exchange membrane (PEM) 120, positioned between an anode 130 and a cathode 140, and an external electrical circuit 142 that electrically connects the anode 130 and the cathode 140. A first microporous layer 150 (also referred to herein as an “anodic microporous layer” (AMPL)) contacts the anode 130. An anode gas diffusion layer (AGDL) 170 contacts the first microporous layer 150 and a first flow channel 190 contacts the anode gas diffusion layer 170. A second microporous layer (also referred to herein as a “cathodic microporous layer” (CMPL)) 160 contacts the cathode 140. A cathode gas diffusion layer (CGDL) 180 contacts the second microporous layer 160 and a second flow channel 200 contacts the cathode gas diffusion layer 180. An anode bipolar plate 210 may contact the first flow channel 190 and a cathode bipolar plate 220 may contact the second flow channel 200.

The fuel gas is typically hydrogen. The hydrogen gas may be stored in a storage tank. Optionally, hydrogen may be stored as metal hydrides or may be hydrogen obtained by reforming a hydrocarbon fuel. The oxidizing gas is typically an oxygen-containing gas. In some embodiments, the oxidizing gas is ambient air. Hydrogen and air flow within the cell are illustrated in FIG. 1A. Hydrogen (H₂) is fed to the anode side of the fuel cell and an oxygen source (such as ambient air) is fed to the cathode side of the fuel cell. At least a portion of the H₂ flows into contact with the anode 130 and migrates to the PEM 120 where H₂ molecules are catalyzed into H⁺ ions plus electrons ‘e-’ (e.g., via an anode catalyst layer 131). Also, at least a portion of the O₂ gas flows into contact with the cathode 140 and migrates to the PEM 120. The electrons e-flow through the external electrical circuit 142 to the cathode 130 and react with O₂ molecules to form O₂-ions (e.g., via the cathode catalyst layer 141) and the H⁺ ions diffuse through the PEM 120 to the cathode 140 and react with the O₂-ions to form H₂O (water), which is then transported out of the PEMFC 100 with the flow of unreacted O₂. In this manner, the Pt-containing nanoparticles assist in and enhance the reaction of O₂+e-to O₂- and/or O₂-+H⁺ to H₂O and electricity is generated by the PEMFC 100. In FIG. 1A, water and excess air are depicted as exiting the cathode side of the fuel cell, and unreacted hydrogen is shown as exiting the anode side of the fuel cell.

The anode bipolar plate 280 and the cathode bipolar plate 290 can independently be made from a metal (such as titanium or stainless steel), or a carbon structure (such as graphite). Some metal bipolar plates use a carbon film coating on some or all surfaces of the bipolar plate. U.S. Pat. No. 10,283,785, incorporated herein by reference, teaches use of an amorphous carbon film in bipolar plates. In the fuel cell, the fuel gas and the oxygen gas should be separately supplied to the entire electrode surfaces without being mixed with each other. Therefore, the bipolar plates should be gas tight. Furthermore, the bipolar plates should collect electrons generated by the reaction and have good electric conductivity in order to serve as electric connectors for connecting adjoining single cells when a plurality of single cells are stacked. Moreover, because proton exchange membrane surfaces are strongly acidic, the bipolar plates provide good corrosion resistance. The main purpose of the bipolar plate in the PEMFC stack is to supply fuel (hydrogen) and oxygen to the cell and also to manage heat produced and water flow. It is also used as a backing medium for stacking individual fuel cells.

The cathode 140 includes a catalyst layer 141 with a plurality of composite particles 141a as illustrated in FIG. 1B, and the composite particles 141a include a plurality of Pt-containing nanoparticles 141b supported on the surface of carbon particles 141c as illustrated in FIG. 1C (only one carbon particle 141c shown). Referring specifically to FIG. 1C, in some examples an ionomer 141d from the PEM 120 is in contact with and at least partially surrounds the composite particles 141a. And in such examples, the ionomer 141d can poison the plurality of Pt-containing nanoparticles 141b (also known as “ionomer poisoning”) such that the efficiency of the catalyst layer 141 decreases. In addition, the plurality of Pt-containing nanoparticles 141b supported on an outer surface of the carbon particle 141c can agglomerate and/or increase in size such that an average effective size of the Pt-containing nanoparticles increases and the efficiency of the catalyst layer 432 decreases.

FIG. 2 is a schematic illustration of a typical membrane-electrode assembly (MEA) 110 comprising a proton exchange membrane 120, an anode 130, and a cathode 140. The anode 130 comprises an anodic catalyst layer 131, configured to electrolytically catalyze an anodic hydrogen-splitting reaction: H₂->2e-+2H⁺. The cathode 140 comprises a cathodic catalyst layer 141, configured to catalyze an oxygen reduction reaction: O₂+4e-+4H⁺->2H₂O.

The catalyst layers can be substantially formed of catalyst particles of platinum or a platinum alloy on a carbon support, such as e.g., carbon black.

Platinum is widely used as a cathode catalyst in electrochemical reactions, such as in fuel cells, because of its exceptional ability to speed up the oxygen reduction reaction (ORR). Platinum acts as an efficient catalyst during the electrochemical reduction of oxygen in a PEMFC by lowering the activation energy, stabilizing intermediates, and steering the ORR towards a more efficient and desired chemical pathway, thus significantly enhancing the overall reaction kinetics and thermodynamics on the Pt (111) surface. Platinum provides a surface that facilitates the transfer of electrons and protons to the adsorbed oxygen species, progressively reducing and splitting the molecule. The presence of platinum ensures that the reaction follows the four-electron pathway directly to water. The lowest energy state is reached with the formation of two (2) water molecules indicating this as the most stable product of the reaction pathway on Pt (111).

Platinum's unique surface properties not only adsorb and activate the reactants but also stabilize the intermediate reaction species, allowing controlled and sequential reaction steps. Previous approaches to producing catalyst particles with a higher catalytic activity and reduced loading of costly precious metals have typically involved the use of one or more components that are susceptible to corrosion in alkaline or acidic environments such as PtM, where M is a transition metal such as Ni, Co, Cu, or Fe. Over time, the gradual loss of these elements and their subsequent buildup in other critical components present within the energy conversion device, e.g., a proton exchange or electrolyte membrane, reduces both the activity level of the catalyst particles and the overall efficiency of the device.

LT-PEMFCs generally employ a proton exchange membrane that conducts proton when the membrane is properly hydrated by water. The typical commercialized membrane is perfluorinated sulfonic-acid (PFSA) having the following chemical structure:

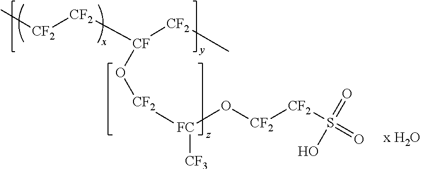

wherein x is 6.5-13.5; y is 200-1000, and z is 1. The PFSA relies on water to conduct protons so that the LT-PEMFCs can be functional. Anhydride PFSA does not conduct proton. Moreover, due to the thermal stability limitation of PFSA polymer, the LT-PEMFCs are usually not stable when operating above 120° C. (glass transition temperature of PFSA).

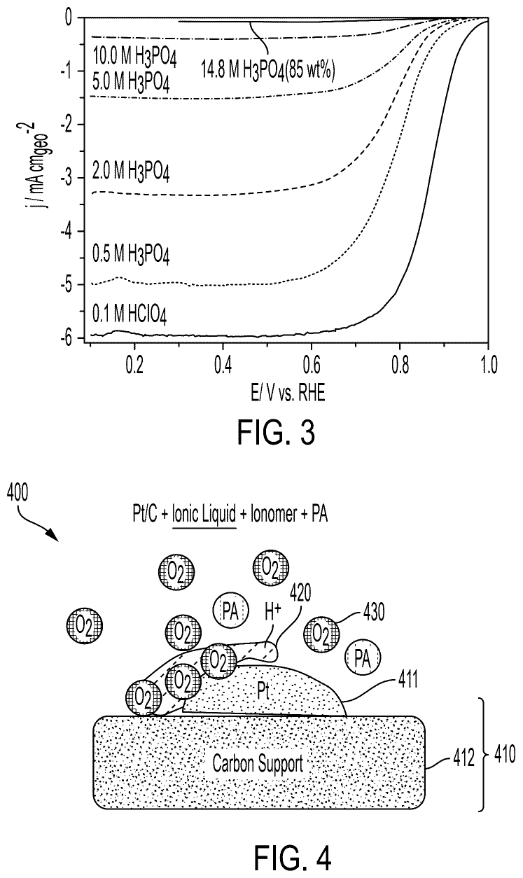

For HT-PEMFCs that can operate above 110° C., preferably above 140° C. and ideally between 160° C.-200° C., water cannot be used for humidifying the proton conductor (electrolyte, typically PFSA) because of the low boiling point (100° C.). A thermally stable proton conductor has to be used for such high temperatures (120° C.-200° C.). Phosphoric acid (PA) is thermally stable at this temperature range and a good proton conductor below 200° C. Above 200° C., phosphoric acid suffers from anhydride formation and evaporation. One major issue with using phosphoric acid (PA) as the proton conductor is poisoning of the oxygen reduction reaction catalyst (typically Pt catalyst). The phosphate anion from phosphoric acid adsorbs on Pt catalyst surface, blocking active sites, and reduces electrochemical surface area (ECSA) and the ability of Pt catalyst to bond with oxygen reduction reaction (ORR) intermediates for electrochemically catalyzing oxygen to form water. Higher concentrations of phosphoric acid from phosphate poisoning result in lower current densities which hinders the overall electrochemical process. As shown in FIG. 3, as the concentration of phosphoric acid increases from a low concentration of 0.5 M H₃PO₄ to a high concentration of 14.8 M H₃PO₄, the current density decreases significantly.

The present disclosure provides a high-temperature proton exchange membrane fuel cell (HT-PEMFC) electrode structure for HT-PEMFCs that employ phosphoric acid as the proton conductor and a method for mitigating phosphate poisoning of the catalyst in the membrane electrode assembly (MEA). The membrane electrode assembly (MEA) of the present disclosure comprises at least one electrode comprising phosphoric acid (PA) as a proton conductor; a proton exchange membrane; at least one catalyst layer which comprises metal catalyst nanoparticles on a carbon support; at least one polymeric ionomer layer; and a buffer layer between the at least one catalyst layer and the at least one polymeric ionomer layer. The buffer layer comprises a protic ionic liquid having a high melting point equal to or greater than 160° C. and the ratio of the protic ionic liquid to carbon (IL/C) is from 0.05 to about 0.2.

FIG. 4 is a schematic illustration of the structure of an electrode 400 of the present disclosure including a buffer layer 420 for HT-PEMFCs and for mitigating phosphate poisoning of the catalyst in a HT-PEMFC. The buffer layer 420 is provided between at least one catalyst layer 410 comprising catalyst nanoparticles 411 on a carbon support 412, and the polymeric ionomer layer 430. The buffer layer 420 is formed by a protic ionic liquid having a high melting point equal to or greater than 160° C. and the ratio of the protic ionic liquid to carbon (IL/C) is from 0.05 to about 0.2.

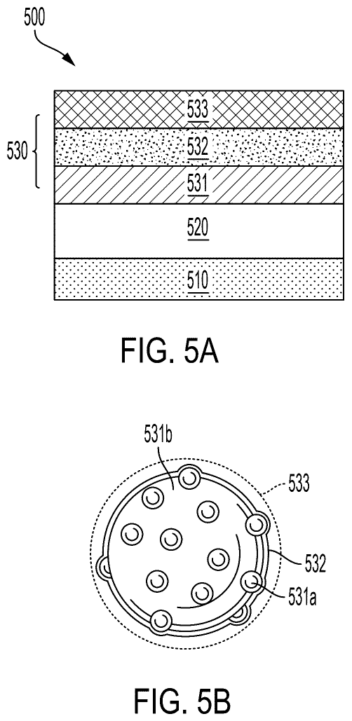

FIG. 5A illustrates a membrane-electrode assembly (MEA) 500 of the present disclosure which comprises a proton exchange membrane 520 between, and in protic communication with an anode electrode 510 and a cathode electrode 530. The cathode electrode 530 comprises at least one catalyst layer 531 contacting the proton exchange membrane 520. The catalyst layer 531 comprises metal catalyst nanoparticles 531a on a carbon support 531b illustrated in FIG. 5B. The cathode electrode 530 of the MEA 500 further comprises at least one polymeric ionomer layer 533, and a buffer layer 532 between the catalyst layer 531 and the polymeric ionomer layer 533. As depicted in FIG. 5A, the catalyst layer 531 comprises metal catalyst nanoparticles 531a on a carbon support 531b. The buffer layer 532 comprises a protic ionic liquid having a high melting point greater than 160° C. The ratio of the protic ionic liquid in the buffer layer 532 to carbon (in the catalyst layer 531) (IL/C) is from about 0.05 to about 0.2.

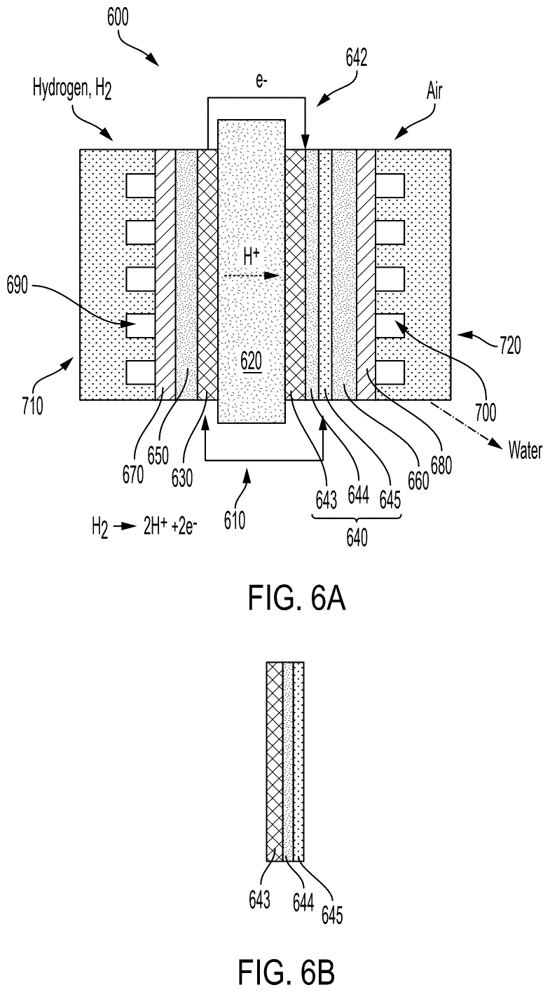

FIG. 6A illustrates an HT-PEMFC 600 which comprises a cathode electrode of the present disclosure illustrated in FIG. 6B. The PEMFC 600 includes a membrane-electrode assembly (MEA) 610, which comprises a proton exchange membrane (PEM) 620, positioned between an anode 630 and a cathode 640, and an external electrical circuit 642 that electrically connects the anode 630 and the cathode 640. In this example of the present disclosure, the cathode 640 includes a catalyst layer 643 which contacts the proton exchange membrane 620, a buffer layer 644 between the catalyst layer 643, and a polymeric ionomer layer 645. A first microporous layer 650 (also referred to herein as an “anodic microporous layer” (AMPL)) contacts the anode 630. An anode gas diffusion layer (AGDL) 670 contacts the first microporous layer 650 and a first flow channel 690 contacts the anode gas diffusion layer 670. A second microporous layer (also referred to herein as a “cathodic microporous layer” (CMPL)) 660 contacts the polymeric ionomeric layer 645 of the cathode 640. A cathode gas diffusion layer (CGDL) 680 contacts the second microporous layer 660 and a second flow channel 700 contacts the cathode gas diffusion layer 680. An anode bipolar plate 710 may contact the first flow channel 690 and a cathode bipolar plate 720 may contact the second flow channel 700.

The buffer layer of the present disclosure is thermally stable and proton conductive to facilitate proton transfer in the electrode for the oxidation reduction reaction (ORR) reaction in the operation temperature range of a HT-PEMFC of about 160° C. to about 200° C. An ionic liquid is used to form the buffer layer of the present disclosure which Is located between the catalyst layer and polymeric ionomer layer. The buffer layer comprises a protic ionic liquid having a high melting point equal to or greater than 160° C. The buffer layer should have a melting point of at least 160° C. to maintain a solid form because the liquid phosphoric acid would leach out (i.e., be flooded out) if the buffer layer is also a liquid. In some examples, the protic ionic liquid of the buffer layer further has a high melting point of between about 160° C. to about 200° C., from about 160° C. to about 180° C., or from about 170° C. to about 180° C. In some examples the protic ionic liquid has a high molecular weight from about 1000 mol/g to about 2000 mol/g, from about 1000 mol/g to about 1200 mol/g, or from about 1100 mol/g to about 1150 mol/g. In some examples, the protic ionic liquid of the buffer layer may have a high melting point of greater than or equal to 160° C. and a high molecular weight of 1000 mol/g or greater. In another example, the protic ionic liquid of the buffer layer has a high melting point in the range of 175° C. to 180° C., and a high molecular weight in the range of 1100 mol/g to 1150 mol/g.

In some examples, the protic ionic liquid is a protic dimeric ionic liquid. In other examples, the protic ionic liquid used to form the buffer layer is a protonated dimeric ionic liquid where two anions are coupled to a protonated dimeric cation. In at least one example, the protonated dimeric ionic liquid comprises 9′9′-(butane-1, 4-diyl)bis(3,4,6,7,8,9-hexahydro-2H-pyrimido[1,2-a]pyrimidin-1-ium) 1,1,2,2,3,3,4,4,4-nonafluorobutane-1-sulfonate, which has the following chemical structure:

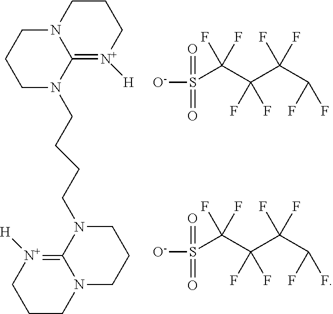 [SMILES: C(CCN1CCCN2CCC[NH+]=C12)CN1CCCN2CCC[NH+]=C12 ; O=S(=O)([O-])C(F)(F)C(F)(F)C(F)(F)C(F)F ; O=S(=O)([O-])C(F)(F)C(F)(F)C(F)(F)C(F)F]

The catalyst layer includes metal catalyst particles, or catalytic metal particles on a carbon support. In some examples, the metal catalyst particles, or catalytic metal particles, are nanoparticles in admixture with or supported by particles of another material, such as carbon, which can be selected from carbon black, graphene, nitrogen-doped carbon, activated carbon, and carbon nanotubes, to form catalyst nanoparticles on a carbon support.

The catalyst particles comprise platinum-containing particles, such as PtM, where M is a metal selected from copper (Cu) iron (Fe), cobalt (Co), nickel (Ni), palladium (Pd), ruthenium (Ru), iridium (Ir), and the like, and combinations thereof. The size and shape of the catalytic metal particles can be optimized to maximize total surface area of the catalyst and reaction sites available to participate in the reactions per volume of catalyst used. In some examples, the particles of a catalytic metal may have a specific surface area of at least 10 m²/g, or 20 m²/g, or 30 m²/g, or 40 m²/g, or 50 m²/g, or 60 m²/g, or 70 m²/g, or 80 m²/g, or 90 m²/g, or 100 m²/g. In some examples, the particles of a catalytic metal will be nanoparticles having an average maximum dimension of less than 100 nm, or less than 90 nm, or less than 80 nm, or less than 70 nm, or less than 60 nm, or less than 50 nm, or less than 40 nm, or less than 30 nm, or less than 20 nm, or less than 10 nm. In some specific examples, the catalyst composition will include platinum nanoparticles having an average maximum dimension of 2-5 nm in diameter. In some examples, the particles of a catalytic metal will include porous particles. In some examples, the particles are nanoparticles, nanowires, and nanorods.

The proton exchange membrane and the polymeric ionomer layer comprise specialized polymer materials having proton conductivity and thermal stability, which is advantageous for use in HT-PEMFCs. Suitable polymers for the proton exchange membrane and/or polymeric ionomer layer of the present disclosure include but are not limited to, phosphoric acid doped polybenzimidazole (PA/PBI), quaternary ammonium phosphate ion pair polymers, polyvinylphosphonic acid (PVPA), sulfonated polyether ether ketone (SPEEK), poly(arylene ether sulfone) (PAES), sulfonated polyimides, perfluorosulfonic acid (PFSA) polyvinylidene fluoride (PVDF) copolymers, and combinations thereof. The polymers may be blended or used to compose composite membranes.

The ratio of the ionic liquid to carbon is an optimal balance of the ionic liquid and carbon in the catalyst which serves to enhance the electrochemical performance, mitigate phosphate poisoning, and improve the thermal stability of the catalyst. In the present disclosure, the ratio of the ionic liquid in the buffer layer to carbon (IL/C) in the catalyst support is from about 0.05 to about 0.2. In some examples, the IL/C is from about 0.1 to about 0.2. In at least one example the IL/C is about 0.15.

The present disclosure also includes membrane electrode assemblies (MEAs) for polymer electrolyte membrane fuel cells (PEMFCs). MEAs of the present teachings include electrodes having composites of catalyst and protonated dimeric ionic liquid. The disclosed MEAs exhibit notably superior performance at low relative humidity, compared to MEAs lacking the protic ionic liquid, across a broad range of current densities. The disclosed MEAs also exhibit notably superior performance at high relative humidity, compared to MEAs lacking the protonated dimeric ionic liquid, at high current densities.

The present disclosure also provides a method for mitigating phosphoric acid poisoning in a HT-PEMFC, which uses phosphoric acid as a proton conductor. In the method of the present disclosure, the buffer layer is applied between the catalyst layer and the polymeric ionomer layer.

The electrode structure comprising a buffer layer for high temperature proton exchange membrane fuels cells and methods for mitigating phosphoric acid poisoning can be applied to fuels cells that involve the use of phosphoric acid as a proton conductor in the membrane electrode assembly (MEAs) including, but not limited to phosphoric acid fuel cells (PAFCs), phosphoric acid doped polybenzimidazole (PA/PBI) membrane PEMFC (PA/PBI PEMFC) and HT-PEMFCs based on quaternary ammonium biphosphate ion-pair coordination (ion-pair HT-PEMFCs). Such fuel cells can be useful for stationary power generation for buildings and industrial applications, automotive applications such as high-efficiency, quick-start fuel cells for vehicles, and portable power devices requiring density and durability.

### Examples

Various aspects of the present disclosure are further illustrated with respect to the following examples. It is to be understood that these examples are provided to illustrate specific embodiments of the present disclosure and should not be construed as limiting the scope of the present disclosure in or to any particular aspect.

### Example 1. Synthesis of Protonated Dimeric Ionic Liquid (PDIL)

1,5,7-Triazabicyclo[4.4.0]dec-5-ene was dissolved in anhydrous tetrahydrofuran, and sodium hydride (NaH) was added to make the sodium salt intermediate shown below.

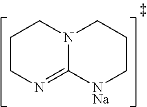

Then 1,4-dibromobutane was added to synthesize the following neutral dimer, which was recovered as a solid.

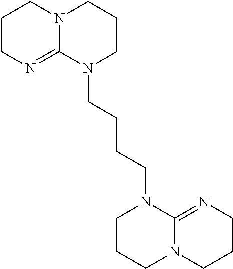 [SMILES: C(CCN1CCCN2CCCN=C12)CN1CCCN2CCCN=C12]

The neutral dimer is dissolved in methanol. Nitric acid is added to the methanol solution to produce a nitrate precursor. Potassium nonafluoro-1-butanesulfonate was then added to produce the dimeric ionic liquid, as shown below. The compound was extracted with dichloromethane.

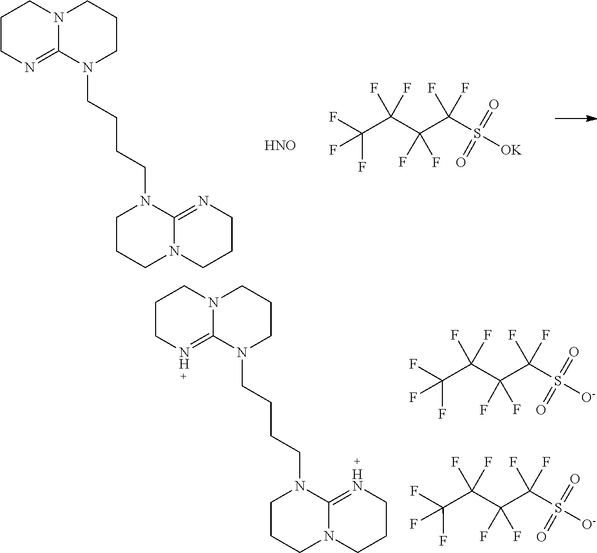

The protic ionic liquid has a high melting point of 179° C. and a high molecular weight of 1146.41 mol/g.

### Example 2. Rotating Disk Electrode (RDE) Evaluation

The catalyst was dispersed in a solution containing 4 mL deionized (DI) water, 2.25 mL isopropanol, 25 μL Nafion dispersion (DE520), and protic dimeric ionic liquid with a different ionic liquid to carbon ratio from 0 to 0.15. The ink was subject to 60 mins ultrasonication in an ice bath. 10 μL of the catalyst ink was pipetted on a clean glassy carbon disk electrode (GC, 5 mm in diameter) and dried in air at room temperature by using an inverted rotator at 200 rpm. The Nafion to carbon ratio was 0.9. The catalyst loading on the electrode was 60 μgₚₜ/cm²Gc. About 200 g H₃PO₄ crystal was melted in oven (80-120° C.) before it is transferred to the electrochemical cell. The cell is then heated to 160° C. in an oil bath for electrochemical measurement. Before immersing the RDE into the electrolyte, one drop of H₃PO₄ was taken by pipette to wet the electrode surface to avoid bubble formation on the electrode surface. CV was conducted in 0.4-1.05 V for 30 cycles with continuous O₂ bubbling. Linear sweep voltammetry (LSV) was scanned from 1.05 V to 0.4 V at 1 mV/s or 10 mV/s. Then the electrode was held at an open circuit potential while the gas was switched to Ar. It takes about 10 min to be Ar-saturated and LSV is measured.

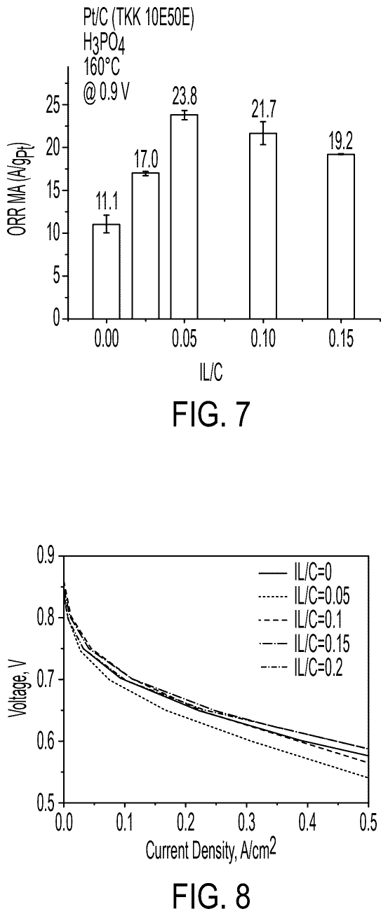

FIG. 7 illustrates the impact of the ionic liquid to carbon ratio on the current density, which is relevant to the performance of the HT-PEMFC. The IL/C ratio was evaluated in MEA from 0 to 0.2. Fuel cell performance at low current density with Pt/C catalyst and buffer layer in cathode electrode at 160° C., 0.5 normal liter per minute (NLPM) H₂/Air, 148 kPa (abs.) The data in FIG. 7 shows improved mass activity within the 0.025 to 0.15 IL/C ratio range on the rotating disk electrode.

The MEA performance with a buffer layer having an IL/C ratio above 0.1 has better performance than Pt/C without a buffer layer. The MEA performance with a buffer layer having an IL/C ratio above 0.2 starts to decrease due to high oxygen transfer resistance (thicker buffer layer). Thus, MEA performance is optimal with a buffer layer having an IL/C ratio between 0.1-0.2.

### Example 3. Coating of Buffer Layer onto the Catalyst

Pt on carbon catalyst with Pt content of 60 wt % was wet with 1 ml deionized water. The ionic liquid was dissolved in 10 ml iso-propanol, which was then added into the wetted Pt catalyst. The slurry was stirred for 2 hours at room temperature and then dried at 50° C. while keeping agitating. After the removal of solvent, the dried catalyst powder was then subject to further drying at 50° C. for at least 24 hours in oven. The finally obtained powder composite was ready for the ink preparation. The ionic liquid-to-carbon ratio was controlled at 0-0.2.

### Example 4. MEA Fabrication

The MEA with and without buffer layer was used to be cathode material and evaluated in the MEA. The catalyst ink consisted of Isopropanol, phosphonated poly(pentafluorostyrene)/Nafion blend ionomer, and catalysts. The ink slurry was vigorously mixed and coated on a carbon cloth gas diffusion layer. The final anode and cathode Pt loading were controlled at 0.7 mgₚₜ/cm². The MEAs were assembled in a 5 cm² single cell with a serpentine flow field (Fuel Cell Technologies).

### Example 5. MEA Evaluation

A membrane assembly electrode (MEA) was constructed to demonstrate the benefit of the buffer layer of the present disclosure to improve the MEA performance. A Greenlight G40 Fuel Cell test system was used for the MEA performance evaluation. The i-V performance of the MEAs were tested at 160° C. Ultrapure H₂ and O₂ were supplied to the anode and cathode with an absolute pressure of 148 Kpa. Full cell performance is illustrated in FIG. 8. As can be seen in FIG. 8, fuel cell performance is significantly improved with a MEA having an IL/C ratio between 0.1-0.2.

Further, the disclosure comprises additional notes and examples as described below.

Clause 1. A membrane electrode assembly (MEA) for a high-temperature proton exchange membrane fuel cell comprising phosphoric acid as a proton conductor, said MEA comprising: a proton exchange membrane; at least one catalyst layer which contact the proton exchange membrane, wherein the catalyst layer comprises metal catalyst nanoparticles on a carbon support; at least one polymeric ionomer layer comprising; and a buffer layer between the metal catalyst nanoparticles and the at least one polymeric ionomer layer, said buffer layer comprising a protic ionic liquid having a high melting point greater than 160° C., and wherein a ratio of the protic ionic liquid to carbon (IL/C) is from about 0.1 to about 0.2.

Clause 2. The MEA according to clause 1, wherein the metal catalyst nanoparticles comprise platinum or platinum alloy.

Clause 3. The MEA according to clause 1 or 2, wherein the protic ionic liquid has a melting point of between about 160° C. to about 200° C.

Clause 4. The MEA according to any one of clauses 1 to 3, wherein the protic ionic liquid has a melting point from about 160° C. to about 180° C.

Clause 5. The MEA according to any one of clauses 1 to 4, wherein the protic ionic liquid has a melting point of from about 170° C. to about 180° C.

Clause 6. The MEA according to any one of clauses 1 to 5, wherein the protic ionic liquid has a high molecular weight greater than 1000 g/mol.

Clause 7. The MEA according to any one of clauses 1 to 6, wherein the protic ionic liquid has a high molecular weight from about 1000 mol/g to about 2000 mol/g.

Clause 8. The MEA according to any one of clauses 1 to 7, wherein the protic ionic liquid has a high molecular weight from about 1000 mol/g to about 1200 mol/g.

Clause 9. The MEA according to any one of clauses 1 to 8, wherein the protic ionic liquid has a molecular weight from about 1100 mol/g to about 1150 mol/g.

Clause 10. The MEA according to any one of clauses 1 to 9, wherein the ratio of the liquid to carbon (IL/C) is from about 0.1 to about 0.2.

Clause 11. The MEA according to any one of clauses 1 to 10, wherein the ratio of the liquid to carbon (IL/C) is about 0.15.

Clause 12. The MEA according to any one of clauses 1 to 11, wherein the protic ionic liquid comprises 9′9′-(butane-1,4-diyl)bis(3,4,6,7,8,9-hexahydro-2H-pyrimido[1,2-a]pyrimidin-1-ium) 1,1,2,2,3,3,4,4,4-nonafluorobutane-1-sulfonate.

Clause 13. The MEA according to any one of clauses 1 to 12, wherein the proton exchange membrane and/or the at least one polymeric ionomer layer comprises phosphoric acid doped polybenzimidazole (PA/PBI), quaternary ammonium phosphate ion pair polymers, polyvinylphosphonic acid (PVPA), sulfonated polyether ether ketone (SPEEK), poly(arylene ether sulfone) (PAES), sulfonated polyimides, perfluorosulfonic acid (PFSA) polyvinylidene fluoride (PVDF) copolymers, and combinations thereof.

Clause 14. A high-temperature proton exchange membrane fuel cell (HT-PEMFC) comprising phosphoric acid as a proton conductor, said HT-PEMFC comprising: a membrane electrode assembly (MEA) for a high-temperature proton exchange membrane fuel cell comprising a proton exchange membrane; at least one catalyst layer which comprises metal catalyst nanoparticles on a carbon support; at least one polymeric ionomer layer; and a buffer layer between the at least one catalyst layer and the at least one polymeric ionomer layer, said buffer layer comprising a protic ionic liquid having a melting point greater than 160° C., and wherein a ratio of the protic ionic liquid to carbon (IL/C) is about 0.5 to about 2.0.

Clause 15. The HT-PEMFC according to clause 14, wherein the metal catalyst nanoparticles comprise platinum or platinum alloy.

Clause 16. The HT-PEMFC according to clause 14 or 15, wherein the protic ionic liquid has a melting point of between about 160° C. to about 200° C.

Clause 17. The HT-PEMFC according to any one of clauses 14 to 16, wherein the protic ionic liquid has a melting point from about 160° C. to about 180° C.

Clause 18. The HT-PEMFC according to any one of clauses 14 to 17, wherein the protic ionic liquid has a melting point of from about 170° C. to about 180° C.

Clause 19. The HT-PEMFC according to any one of clauses 14 to 18, wherein the protic ionic liquid has a high molecular weight greater than 1000 g/mol.

Clause 20. The HT-PEMFC according to any one of clauses 14 to 19, wherein the protic ionic liquid has a high molecular weight from about 1000 mol/g to about 2000 mol/g.

Clause 21. The HT-PEMFC according to any one of clauses 14 to 20, wherein the protic ionic liquid has a high molecular weight from about 1000 mol/g to about 1200 mol/g.

Clause 22. The HT-PEMFC according to any one of clauses 14 to 21, wherein the protic ionic liquid has a molecular weight from about 1100 mol/g to about 1150 mol/g.

Clause 23. The HT-PEMFC according to any one of clauses 14 to 22, wherein the ratio of the liquid to carbon (IL/C) is from about 0.1 to about 0.2.

Clause 24. The HT-PEMFC according to any one of clauses 14 to 22, wherein the ratio of the liquid to carbon (IL/C) is about 0.15.

Clause 25. The HT-PEMFC according to any one of clauses 14 to 24, wherein the protic ionic liquid comprises 9′9′-(butane-1,4-diyl)bis(3,4,6,7,8,9-hexahydro-2H-pyrimido[1,2-a]pyrimidin-1-ium) 1, 1,2,2,3,3,4,4,4-nonafluorobutane-1-sulfonate.

Clause 26. The HT-PEMFC according to any one of clauses 14 to 25, wherein the proton exchange membrane and/or the at least one polymeric ionomer layer comprises phosphoric acid doped polybenzimidazole (PA/PBI), quaternary ammonium phosphate ion pair polymers, polyvinylphosphonic acid (PVPA), sulfonated polyether ether ketone (SPEEK), poly(arylene ether sulfone) (PAES), sulfonated polyimides, perfluorosulfonic acid (PFSA) polyvinylidene fluoride (PVDF) copolymers, and combinations thereof.

Clause 27. A method of mitigating phosphoric acid poisoning in a high-temperature proton exchange membrane fuel cell (HT-PEMFC) comprising phosphoric acid as a proton conductor, said method comprising: providing at least one catalyst layer which comprises metal catalyst nanoparticles on a carbon support and at least one polymeric ionomer layer; and applying a buffer layer between the at least one catalyst layer and the at least one polymeric ionomer layer, said buffer layer comprising a protic ionic liquid having a high melting point greater than 160° C., and wherein a ratio of the protic ionic liquid to carbon (IL/C) is about 0.5 to about 2.0.

Clause 28. The method according to clause 27, wherein the metal catalyst nanoparticles comprise platinum or platinum alloy.

Clause 29. The HT-PEMFC according to clause 27 or 28, wherein the protic ionic liquid has a melting point of between about 160° C. to about 200° C.

Clause 30. The HT-PEMFC according to any one of clauses 27 to 29, wherein the protic ionic liquid has a melting point from about 160° C. to about 180° C.

Clause 31. The HT-PEMFC according to any one of clauses 27 to 30, wherein the protic ionic liquid has a melting point of from about 170° C. to about 180° C.

Clause 32. The HT-PEMFC according to any one of clauses 27 to 31, wherein the protic ionic liquid has a high molecular weight greater than 1000 g/mol.

Clause 33. The HT-PEMFC according to any one of clauses 27 to 32, wherein the protic ionic liquid has a high molecular weight from about 1000 mol/g to about 2000 mol/g.

Clause 34. The HT-PEMFC according to any one of clauses 27 to 33, wherein the protic ionic liquid has a high molecular weight from about 1000 mol/g to about 1200 mol/g.

Clause 35. The HT-PEMFC according to any one of clauses 27 to 34, wherein the protic ionic liquid has a molecular weight from about 1100 mol/g to about 1150 mol/g.

Clause 36. The HT-PEMFC according to any one of clauses 27 to 35, wherein the ratio of the liquid to carbon (IL/C) is from about 0.1 to about 0.2.

Clause 37. The HT-PEMFC according to any one of clauses 27 to 36, wherein the ratio of the liquid to carbon (IL/C) is about 0.15.

Clause 38. The HT-PEMFC according to any one of clauses 27 to 37, wherein the protic ionic liquid comprises 9′9′-(butane-1,4-diyl)bis(3,4,6,7,8,9-hexahydro-2H-pyrimido[1,2-a]pyrimidin-1-ium) 1,1,2,2,3,3,4,4,4-nonafluorobutane-1-sulfonate.

Clause 39. The HT-PEMFC according to any one of clauses 27 to 38, wherein the proton exchange membrane and/or the at least one polymeric ionomer layer comprises phosphoric acid doped polybenzimidazole (PA/PBI), quaternary ammonium phosphate ion pair polymers, polyvinylphosphonic acid (PVPA), sulfonated polyether ether ketone (SPEEK), poly(arylene ether sulfone) (PAES), sulfonated polyimides, perfluorosulfonic acid (PFSA) polyvinylidene fluoride (PVDF) copolymers, and combinations thereof.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple embodiments having stated features is not intended to exclude other embodiments having additional features, or other embodiments incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an embodiment can or may comprise certain elements or features does not exclude other embodiments of the present technology that do not contain those elements or features.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an embodiment or particular system is included in at least one embodiment or aspect. The appearances of the phrase “in one aspect” (or variations thereof) are not necessarily referring to the same aspect or embodiment. It should be also understood that the various method steps discussed herein do not have to be carried out in the same order as depicted, and not each method step is required in each aspect or embodiment.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

1. A membrane electrode assembly (MEA) for a high-temperature proton exchange membrane fuel cell comprising phosphoric acid as a proton conductor, said MEA comprising:
a proton exchange membrane;
at least one catalyst layer which contact the proton exchange membrane, wherein the catalyst layer comprises metal catalyst nanoparticles on a carbon support;
at least one polymeric ionomer layer; and
a buffer layer between the metal catalyst nanoparticles and the at least one polymeric ionomer layer, said buffer layer comprising a protic ionic liquid having a high melting point greater than 160° C., and wherein a ratio of the protic ionic liquid to carbon (IL/C) is from about 0.1 to about 0.2.

2. The MEA according to claim 1, wherein the metal catalyst nanoparticles comprise platinum or platinum alloy.

3. The MEA according to claim 1, wherein the protic ionic liquid has a high molecular weight greater than 1000 g/mol.

4. The MEA according to claim 1, wherein the ratio of the liquid to carbon (IL/C) is from about 0.1 to about 0.2.

5. The MEA according to claim 1, wherein the ratio of the liquid to carbon (IL/C) is about 0.15.

6. The MEA according to claim 1, wherein the protic ionic liquid comprises 9′9′-(butane-1,4-diyl)bis(3,4,6,7,8,9-hexahydro-2H-pyrimido[1,2-a]pyrimidin-1-ium) 1,1,2,2,3,3,4,4,4-nonafluorobutane-1-sulfonate.

7. The MEA according to claim 1, wherein the proton exchange membrane and/or the at least one polymeric ionomer layer comprises phosphoric acid doped polybenzimidazole (PA/PBI), quaternary ammonium phosphate ion pair polymers, polyvinylphosphonic acid (PVPA), sulfonated polyether ether ketone (SPEEK), poly(arylene ether sulfone) (PAES), sulfonated polyimides, perfluorosulfonic acid (PFSA) polyvinylidene fluoride (PVDF) copolymers, and combinations thereof.

8. A high-temperature proton exchange membrane fuel cell (HT-PEMFC) comprising phosphoric acid as a proton conductor, said HT-PEMFC comprising:
a membrane electrode assembly (MEA) for a high-temperature proton exchange membrane fuel cell comprising a proton exchange membrane; at least one catalyst layer which comprises metal catalyst nanoparticles on a carbon support; at least one polymeric ionomer layer; and a buffer layer between the at least one catalyst layer and the at least one polymeric ionomer layer, said buffer layer comprising a protic ionic liquid having a melting point greater than 160° C., and wherein a ratio of the protic ionic liquid to carbon (IL/C) is about 0.5 to about 2.0.

9. The high-temperature proton exchange membrane fuel cell according to claim 8, wherein the metal catalyst nanoparticles comprise platinum or platinum alloy.

10. The high-temperature proton exchange membrane fuel cell according to claim 8, wherein the protic ionic liquid has a high molecular weight of greater than 1000 mol/g.

11. The high-temperature proton exchange membrane fuel cell according to claim 8, wherein the ratio of the liquid to carbon (IL/C) is from about 0.1 to about 0.2.

12. The high-temperature proton exchange membrane fuel cell according to claim 8, wherein the ratio of the protic ionic liquid to carbon (IL/C) is about 0.15.

13. The high-temperature proton exchange membrane fuel cell according to claim 8, wherein the protic ionic liquid comprises 9′9′-(butane-1, 4-diyl)bis(3,4,6,7,8,9-hexahydro-2H-pyrimido[1,2-a]pyrimidin-1-ium) 1,1,2,2,3,3,4,4,4-nonafluorobutane-1-sulfonate.

14. The high-temperature proton exchange membrane fuel cell according to claim 8, wherein the proton exchange membrane and/or the at least one polymeric ionomer layer comprises phosphoric acid doped polybenzimidazole (PA/PBI), quaternary ammonium phosphate ion pair polymers, polyvinylphosphonic acid (PVPA), sulfonated polyether ether ketone (SPEEK), poly(arylene ether sulfone) (PAES), sulfonated polyimides, perfluorosulfonic acid (PFSA) polyvinylidene fluoride (PVDF) copolymers, and combinations thereof.

15. A method of mitigating phosphoric acid poisoning in a high-temperature proton exchange membrane fuel cell (HT-PEMFC) comprising phosphoric acid as a proton conductor, said method comprising:
providing at least one catalyst layer which comprises metal catalyst nanoparticles on a carbon support and at least one polymeric ionomer layer; and
applying a buffer layer between the at least one catalyst layer and the at least one polymeric ionomer layer, said buffer layer comprising a protic ionic liquid having a high melting point greater than 160° C., and wherein a ratio of the protic ionic liquid to carbon (IL/C) is about 0.5 to about 2.0.

16. The method according to claim 15, wherein the metal catalyst nanoparticles comprise platinum or platinum alloy.

17. The method according to claim 15, wherein the protic ionic liquid further has a high molecular weight of greater than 1000 mol/g.

18. The method according to claim 15, wherein the ratio of the protic ionic liquid to carbon (IL/C) is from about 0.1 to about 0.2.

19. The method according to claim 15, wherein the ratio of the protic ionic liquid to carbon (IL/C) is about 0.15.

20. The method according to claim 15, wherein the protic ionic liquid comprises 9′9′-(butane-1,4-diyl)bis(3,4,6,7,8,9-hexahydro-2H-pyrimido[1,2-a]pyrimidin-1-ium) 1,1,2,2,3,3,4,4,4-nonafluorobutane-1-sulfonate.

21. The method according to claim 15, wherein the proton exchange membrane and/or the at least one polymeric ionomer layer comprises phosphoric acid doped polybenzimidazole (PA/PBI), quarternary quaternary ammonium phosphate ion pair polymers, polyvinylphosphonic acid (PVPA), sulfonated polyether ether ketone (SPEEK), poly(arylene ether sulfone) (PAES), sulfonated polyimides, perfluorosulfonic acid (PFSA) polyvinylidene fluoride (PVDF) copolymers, and combinations thereof.
